(19) United States
(12) Patent Application Publication
(10) Pub. No.: US 2016/0217748 A1
(43) Pub. Date: Jul. 28, 2016

(54) DATA LINE DRIVING CIRCUIT OF ELECTROOPTICAL DEVICE, ELECTROOPTICAL APPARATUS, AND ELECTRONIC APPARATUS

(71) Applicant: Seiko Epson Corporation, Tokyo (JP)

(72) Inventor: Daisuke Abe, Chino-shi (JP)

(21) Appl. No.: 14/988,930

(22) Filed: Jan. 6, 2016

(30) Foreign Application Priority Data
Jan. 22, 2015 (JP) 2015-010207

(51) Int. Cl. G09G 3/34

(52) U.S. Cl. CPC G09G 3/344; G09G 2330/023; G09G 2310/0278; G09G 2310/0286; G09G 2310/08

(57) ABSTRACT

In a data line driving circuit that supplies data signals to each data line provided at a first column to an nth column, unit circuits of n+1st to n+3rd tiers are provided on the subsequent tier of a unit circuit Un of n tiers of a shift register corresponding to the nth column, and a start pulse transmitted to the n tier is further transmitted from the n+1st tier to the n+3rd tier. By an OR gate, a latch pulse with a pulse width wider than the start pulse is generated by performing a logical OR of the start pulse transmitted from the n+1st tier to the n+3rd tier. The data signals latched in the first latching circuit by the sampling signal are simultaneously latched in the second latching circuit by the latch pulse.

### BACKGROUND

1. Technical Field

The present invention relates to a data line driving circuit of an electrooptical device, the electrooptical device, and an electronic apparatus.

2. Related Art

As an example of an electrooptical device operated by sequentially selecting a display element arranged in a matrix form to demonstrate a predetermined function, an electrophoretic display device is generally becoming to be used. Electrophoresis is a phenomenon in which, for example, if the action of an electric field is performed in a disperse system in which fine particles are dispersed in liquid, the fine particle travels (phoresis) in the liquid by Coulomb's force. The electrophoretic display device displays desired information (image) by using the electrophoresis.

In the electrophoretic display device, a driving method is applied of sequentially selecting a scanning line arranged at each row of a displaying section, latching a subsequent data signal by a first latching circuit based on a sampling signal provided from a shift resistor at the timing when the scanning line of each row is selected, providing a latch pulse at the timing when the latching of a data signal of all pixels of the corresponding row is finished, simultaneously latching the data signal of all the pixels of the corresponding row by a second latching circuit, and simultaneously writing the data signal in all the pixels of the corresponding row (for example, JP-A-2006-119409).

In a device according to JP-A-2006-119409, an end pulse output from the last tier of the shift register is used as the latch pulse. However, the end pulse generally has only the pulse width of one clock. Therefore, a time for transmitting the data signal from a first latch to a second latch is insufficient, and it is highly likely that a display defect is generated. In order to avoid such a display defect, it is considered that a large buffer is installed on the last tier of the shift register to increase driving capability of a second latch line. However, there is a problem that, since, in this buffer, especially the channel width of a transistor on the last tier becomes exceptionally long, large amount of leak current is generated according to the characteristics of the transistor, and large amount of electricity is consumed.

### SUMMARY

An advantage of some aspects of the invention is to realize a data line driving circuit of an electrooptical device that is capable of preventing the display defect, while suppressing the increase of the electricity consumption, even when line-sequentially driving the display element arranged in a matrix form.

According to an aspect of the invention, there is provided a data line driving circuit of an electrooptical device which includes a displaying section that includes a plurality of pixels arranged in a matrix form, a scanning line driving circuit, and a data line driving circuit, in which writing of a data signal is performed through a data line for each of the plurality of pixels corresponding to one scanning line, the circuit including a first latching circuit that latches the data signal to be written in the pixel of each column corresponding to the one scanning line by a sampling signal corresponding to each column, a shift register that transmits a predetermined pulse signal and outputs the sampling signal corresponding to each column, a second latching circuit that simultaneously latches the data signal to be written in the pixel of each column latched in the first latching circuit by a latch pulse signal and supplies the data signal to the data line of each column, and a pulse generating circuit that generates a latch pulse signal of a pulse width wider than the pulse width of the predetermined pulse signal based on the predetermined pulse signal transmitted to a tier corresponding to the last column in order to generate the sampling signal corresponding to the last column output from the shift register.

According to the aspect, in order to write the data signal to the pixel of each column corresponding to the one scanning line, when the predetermined pulse signal is output, the shift register transmits the predetermined pulse signal and outputs the sampling signal corresponding to each column based on the transmitted predetermined pulse signal. The first latching circuit latches the data signal to be written in the pixel of each column corresponding to the one scanning line based on the sampling signal corresponding to each column. When the predetermined pulse signal is transmitted to the tier corresponding to the last column, the shift register outputs the sampling signal corresponding to the last column. However, the pulse generating circuit generates a latch pulse signal of the pulse width wider than the pulse width of the predetermined pulse signal based on the predetermined pulse signal transmitted to the tier corresponding to the last column. The second latching circuit simultaneously latches the data signal to be written in the pixel of each column latched in the first latching circuit by the latch pulse signal output from the pulse generating circuit and supplies the data signal to the data line of each column. Since the pulse width of the latch pulse signal is wider than the pulse width of the predetermined pulse signal, the data signal is supplied to the data line of each column with time to spare. Therefore, there is no need for a large buffer, it is possible to suppress the increase of the electricity consumption and to prevent a display defect. In addition, in the aspect, the “predetermined pulse signal” is a concept including a start pulse. Moreover, an “electrooptical device” is a concept including a liquid crystal display device, an organic EL display device, an inorganic EL display device, an electrophoretic display device, an electrochromic display device, and the like.

In the data line driving circuit of an electrooptical device according to another aspect of the invention, the pulse generating circuit includes a circuit transmitting the predetermined pulse signal, further transmits the predetermined pulse signal transmitted to the tier corresponding to the last column at the interval shorter than the pulse width of the corresponding pulse signal for a plurality of tiers, and generates the latch pulse signal of the pulse width wider than the pulse width of the predetermined pulse signal by performing a logical OR of the transmitted plurality of pulse signals. According to this aspect, the pulse generating circuit further transmits the predetermined pulse signal transmitted to the tier corresponding to the last column by the shift register at the interval shorter than the pulse width of the corresponding pulse signal for a plurality of tiers. In addition, by using an OR gate or the like, the latch pulse signal of a pulse width wider than the pulse width of the predetermined pulse signal is generated by performing the logical OR of the transmitted plurality of the pulse signals. Therefore, it is possible to securely generate the latch pulse signal of the wide pulse width with a simple configuration.

In the data line driving circuit of an electrooptical device according to still another aspect of the invention, the pulse generating circuit includes an SR flip-flop circuit, and, while inputting the predetermined pulse signal transmitted to the tier corresponding to the last column into a set input terminal of the SR flip-flop circuit, inputs the predetermined pulse signal before the transmission is performed by the shift register into a reset input element of the SR flip-flop circuit to generate the latch pulse signal of the pulse width wider than the pulse width of the predetermined pulse signal. According to this aspect, when the predetermined pulse signal transmitted to the tier corresponding to the last column by the shift register is input into the set input terminal of the SR flip-flop circuit, the level of an output signal of the SR flip-flop circuit is raised from an L level to an H level. In addition, if the predetermined pulse signal is output for the writing of the next row, and the predetermined pulse signal is input to the reset input terminal of the SR flip-flop circuit, the level of the output signal of the SR flip-flop circuit is lowered from an H level to an L level. Therefore, the latch pulse signal generated as the output signal of the SR flip-flop circuit has a pulse width corresponding to a duration from the timing when the predetermined pulse signal is transmitted to the tier corresponding to the last column to the timing when the predetermined pulse signal is output for the writing of the next row. In this manner, according to this aspect, it is possible to securely generate the latch pulse signal of the wide pulse width with a simple configuration.

In the data line driving circuit of an electrooptical device according to still another aspect of the invention, the pulse generating circuit includes an D flip-flop circuit in which a reverse output terminal and a data input terminal are connected, and inputs the predetermined pulse signal transmitted to the tier corresponding to the last column, or the predetermined pulse signal before the transmission is performed by the shift register into a clock terminal of the D flip-flop circuit to generate the latch pulse signal of the pulse width wider than the pulse width of the predetermined pulse signal. According to this aspect, when the predetermined pulse signal transmitted to the tier corresponding to the last column by the shift register is input into the clock terminal of the D flip-flop circuit, the level of an output signal of the D flip-flop circuit is raised from an L level to the an H level. In addition, if the predetermined pulse signal is output for the writing of the next row, and the predetermined pulse signal is input to the clock terminal of the predetermined D flip-flop circuit, the level of the output signal of the D flip-flop circuit is lowered from the H level to the L level. Therefore, the latch pulse signal generated as the output signal of the D flip-flop circuit has a pulse width corresponding to a duration from the timing when the predetermined pulse signal is transmitted to the tier corresponding to the last column to the timing when the predetermined pulse signal is output for the writing of the next row. In this manner, according to this aspect, it is possible to securely generate the latch pulse signal of the wide pulse width with a simple configuration.

Next, according to still another aspect of the invention, there is provided an electrooptical device including the data line driving circuit according to the aspects of the invention described above. This electrooptical device is capable of preventing the display defect while suppressing the increase of the electricity consumption. Moreover, the electrooptical device is a concept including a liquid crystal display device, an organic EL display device, an inorganic EL display device, an electrophoretic display device, an electrochromic display device, and the like.

Next, according to still another aspect of the invention, there is provided an electronic apparatus including the electrooptical device according to the aspects of the invention described above. This electronic apparatus is capable of preventing the display defect while suppressing the increase of the electricity consumption. In addition, the electronic apparatus is a concept including a tablet, an electronic book, a smartphone, and the like.

### BRIEF DESCRIPTION OF THE DRAWINGS

The invention will be described with reference to the accompanying drawings, wherein like numbers reference like elements.

FIG. 1 is a block diagram illustrating a major configuration of an electrooptical device according to a first embodiment of the invention.

FIG. 2 is a diagram illustrating an example of the configuration of a pixel circuit.

FIG. 3 is a cross-section diagram of a displaying section.

FIG. 4 is a configuration diagram of a microcapsule.

FIG. 5 is a diagram illustrating the operation of the microcapsule.

FIG. 6 is a diagram illustrating the operation of the microcapsule.

FIG. 7 is a block diagram illustrating an example of the configuration of a data line driving circuit.

FIG. 8 is a circuit diagram illustrating an example of the configuration of a data line driving circuit.

FIG. 9 is a timing chart of a writing of one row of the data line driving circuit.

FIG. 10 is a circuit diagram illustrating an example of the configuration of a data line driving circuit according to a second embodiment.

FIG. 11 is a timing chart of a writing of one row of the data line driving circuit according to the second embodiment.

FIG. 12 is a circuit diagram illustrating an example of the configuration of a data line driving circuit according to a third embodiment.

FIG. 13 is a timing chart of a writing of one row of the data line driving circuit according to the third embodiment.

FIG. 14 is a perspective view of an electronic apparatus (information terminal).

FIG. 15 is a perspective view of an electronic apparatus (electronic paper).

FIG. 16 is a circuit diagram illustrating a data line driving circuit according to a comparative example.

FIG. 17 is a timing chart of a writing of one row of the data line driving circuit according to the comparative example.

### DESCRIPTION OF EXEMPLARY EMBODIMENTS

### First Embodiment

Hereinafter, the first embodiment of the invention will be described.

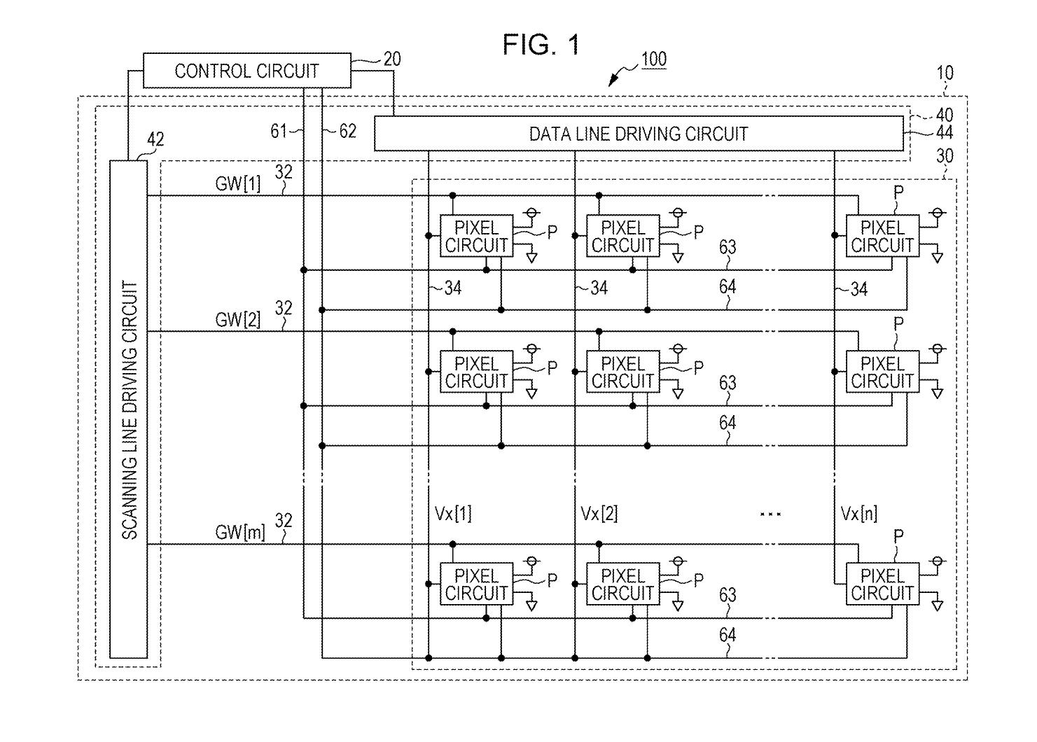

FIG. 1 is a block diagram illustrating a major configuration of an electrophoretic display device 100 as an example of an electrooptical device according to the first embodiment of the invention. As illustrated in the drawing, the electrophoretic display device 100 includes an electrophoretic panel 10 and a control circuit 20.

The electrophoretic panel 10 includes a displaying section 30 on which a plurality of pixel circuits P are displayed, and a driving section 40 that drives each of the pixel circuits P. The driving section 40 includes a scanning line driving circuit 42 and a data line driving circuit 44.

The control circuit 20 integrally controls each portion of the electrophoretic panel 10 based on a video signal, a synchronization signal, or the like supplied from the upper level device.

On the displaying section 30, an m number of scanning lines 32 extending in an X direction as an example of a second control line, and an n number of data lines 34 extending in a Y direction as an example of a first control line and intersecting with the scanning lines 32 are formed (m and n are natural numbers). The plurality of the pixel circuits P are arranged to intersect with the scanning lines 32 and the data lines 34 in a matrix form of horizontally m rows and vertically n columns.

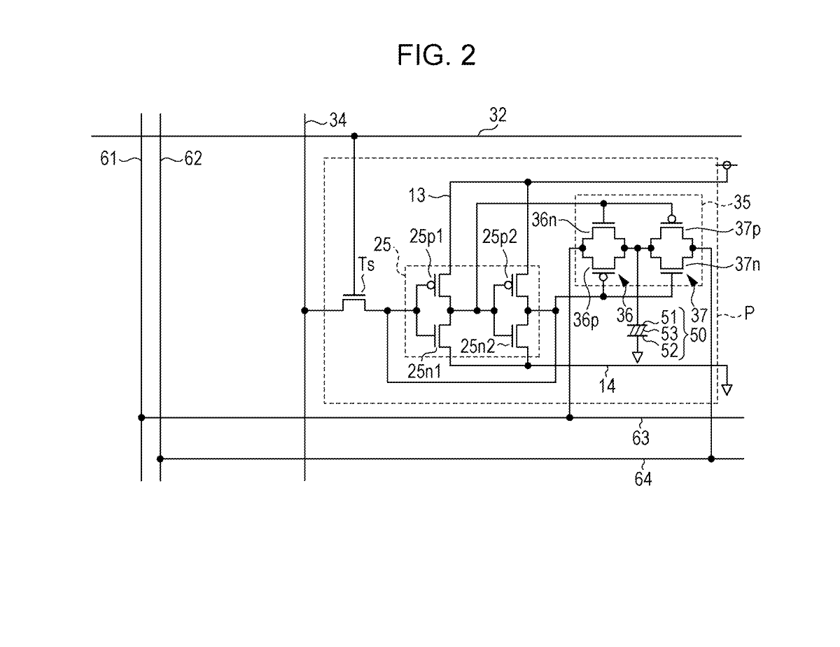

FIG. 2 is a diagram illustrating an example of the configuration of the pixel circuits P. In FIG. 2, only one pixel circuit (pixel) P positioned at an ith row (1≦i≦m) and a jth column (1≦j≦n) is illustrated. As illustrated in the drawing, the pixel circuits P include an electrophoretic element 50, a selecting switch Ts, a memory circuit 25, and a switch circuit 35.

The selecting switch Ts is configured by an negative metal oxide semiconductor (N-MOS). The scanning lines 32 are connected at a gate portion of the selecting switch Ts, the data lines 34 are connected at a source side, and the memory circuit 25 is connected at a drain side, respectively. The selecting switch Ts is used to input a data signal input from the data line driving circuit 44 through the data lines 34 into the memory circuit 25 by connecting the data lines 34 and the memory circuit 25 during a duration when a scanning signal is input from the scanning line driving circuit 42 through the scanning lines 32.

The memory circuit 25 is a latching circuit, and is configured by two positive metal oxide semiconductors (P-MOS) 25p1 and 25p2, and two N-MOSs 25n1 and 25n2. A first power source line 13 is connected at a source side of the P-MOSs 25p1 and 25p2, and a second power source line 14 is connected at a source side of the N-MOSs 25n1 and 25n2. Therefore, the source side of the P-MOSs 25p1 and 25p2 is a high-electric potential power source terminal of the memory circuit 25, and the source side of the N-MOSs 25n1 and 25n2 is a low-electric potential power source terminal of the memory circuit 25.

In addition, the switch circuit 35 as an example of a pixel electrode switch circuit includes a first transfer gate 36 and a second transfer gate 37. The first transfer gate 36 includes a P-MOS 36p and an N-MOS 36n. The second transfer gate 37 includes a P-MOS 37p and an N-MOS 37n.

The source side of the first transfer gate 36 is connected with a first branch power source line 63, and the source side of the second transfer gate 37 is connected with a second branch power source line 64. At a drain side of the transfer gates 36 and 37, a pixel electrode 51 is connected.

The memory circuit 25 includes an input terminal N1 connected with the drain side of the selecting switch Ts and a first output terminal N2 and a second output terminal N3 connected with the switch circuit 35.

The gate portion of the P-MOS 25p1 and the gate portion of the N-MOS 25n1 of the memory circuit 25 function as the input terminal N1 of the memory circuit 25. The input terminal N1 is, while being connected to the drain side of the selecting switch Ts, connected to the first output terminal N2 (the drain side of the P-MOS 25p2 and the drain side of the N-MOS 25n2) of the memory circuit 25.

Furthermore, the first output terminal N2 is connected to the gate portion of the P-MOS 36p of the first transfer gate 36 and the gate portion of the N-MOS 37n of the second transfer gate 37.

The gate portion of the P-MOS 25p2 and the gate portion of the N-MOS 25n2 of the memory circuit 25 function as the second output terminal N3 of the memory circuit 25.

The second output terminal N3 is, while being connected to the drain side of the P-MOS 25p1 and the drain side of the N-MOS 25n1, connected to the gate portion of the N-MOS 36n of the first transfer gate 36 and the gate portion of the P-MOS 37p of the second transfer gate 37.

The memory circuit 25 is, while maintaining the data signal transmitted from the selecting switch Ts, used to input the data signal into the switch circuit 35.

The switch circuit 35 alternatively selects any of the first and second branch power source lines 63 and 64 based on the data signal input from the memory circuit 25, and functions as a selector that connects with the pixel electrode 51. Here, only one of the first and second transfer gates 36 and 37 operates in accordance with the level of the data signal.

Specifically, when a high level (H) is input to the input terminal N1 of the memory circuit 25 as the data signal, the high level (H) is output from the first output terminal N2. Therefore, in a transistor connected to the first output terminal N2 (input terminal N1), the N-MOS 37n is operated, and the P-MOS 37p connected to the second output terminal N3 is operated, and thereby the transfer gate 37 is driven. Thereby, the first branch power source line 63 and the pixel electrode 51 are electrically connected.

Meanwhile, when a low level (L) is input to the input terminal N1 of the memory circuit 25 as the data signal, the low level (L) is output from the first output terminal N2. Therefore, in a transistor connected to the first output terminal N2 (input terminal N1), the P-MOS 36p is operated, and the N-MOS 36n connected to the second output terminal N3 is operated, and thereby the transfer gate 36 is driven. Thereby, the second branch power source line 64 and the pixel electrode 51 are electrically connected.

In addition, through the operated transfer gate, conduction is performed between the first branch power source line 63 or the second branch power source line 64 and the pixel electrode 51, and an electric potential is input to the pixel electrode 51.

Moreover, the memory circuit 25 is capable of maintaining the data signal input through the selecting switch Ts as described above as an electric potential, and of maintaining the state of the switch circuit 35 without refresh operation at regular intervals. Therefore, it is possible to maintain the electric potential of the pixel electrode 51 by the function of the memory circuit 25. In addition, since it is possible to provide a plurality of output terminals that output different signals, appropriate control adapted for the configuration of the switch circuit 35 is possible.

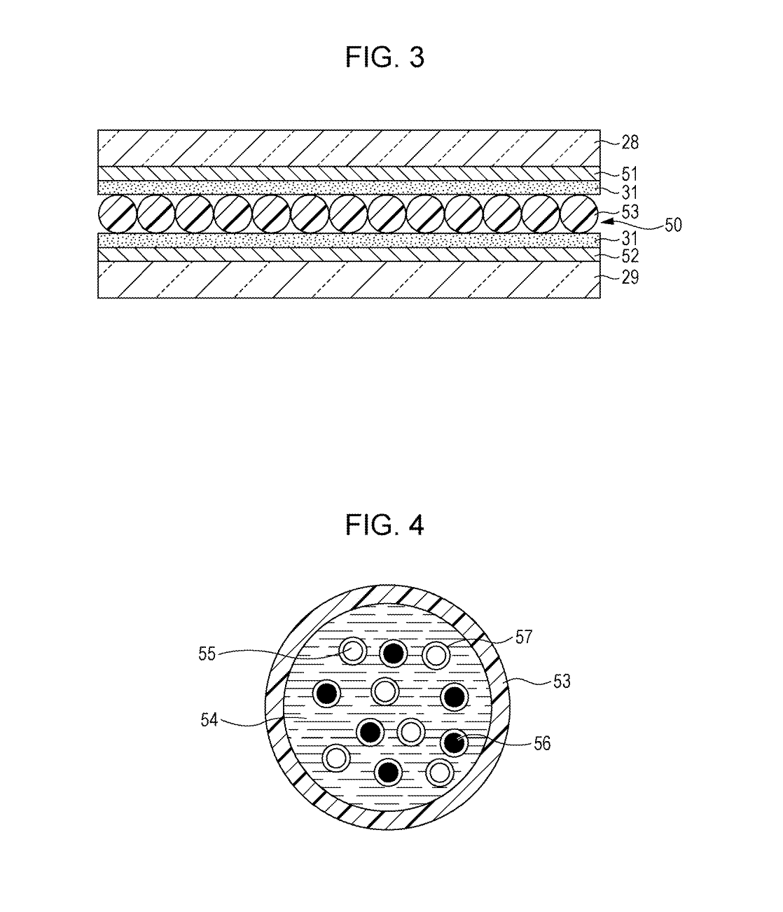

The electrophoretic element 50 includes, as described in FIG. 3, the pixel electrode 51 and a common electrode 52 facing each other, and a plurality of microcapsules 53 arranged between the pixel electrode 51 and the common electrode 52. In this embodiment, the common electrode 52 side is an electrode at an observation side. In addition, the common electrode is also referred as a facing electrode, since the common electrode is an electrode facing the pixel electrode 51. However, in this embodiment, it will be described as a common electrode.

The electrophoretic element 50 as an example of a display element is configured by a plurality of the microcapsules 53. The electrophoretic element 50 is fixed between an element substrate 28 and a facing substrate 29 by an adhesive layer 31. That is, the adhesive layer 31 is formed between the electrophoretic element 50 and both of the substrates 28 and 29.

In addition, the adhesive layer 31 at the element substrate 28 side is required for adhesion with the pixel electrode 51. However, the adhesive layer 31 at the facing substrate 29 is not essential. This is because that a case is presumed where, it is only the adhesive layer 31 at the element substrate 28 side that is required as the adhesive layer 31 at the facing substrate 29 side in the case of treating the common electrode 52, a plurality of the microcapsules 53, and the adhesive layer 31 as an electrophoretic sheet after manufacturing thereof in a consistent manufacturing process, in advance, with regard to the facing substrate 29.

The element substrate 28 is, for example, a substrate formed of glass, plastic, or the like. The pixel electrodes 51 are formed on the element substrate 28, and each of the pixel electrodes 51 is formed in a rectangular shape for each of the pixel circuits P. Though not illustrated, at the area between each of the pixel electrodes 51 or on the lower surface of the pixel electrodes 51 (a layer at the element substrate 28 side), the scanning line 32, the data line 34, the first branch power source line 63, the second branch power source line 64, the power source lines 13 and 14, the selecting switch Ts, the memory circuit 25, the switch circuit 35, and the like illustrated in FIGS. 1 and 2 are formed.

Since the facing substrate 29 is the side on which an image is displayed, the facing substrate 29 is a substrate having light-transmissivity as in glass or the like. For the common electrode 52 formed on the facing substrate 29, a material having light-transmissivity and conductivity is used, for example, such as magnesium-silver (MgAg), indium tin oxide (ITO), indium zinc oxide (IZO), or the like.

In addition, generally, the electrophoretic element 50 is formed at the facing substrate 29 side in advance, and treated as an electrophoretic sheet including up to the adhesive layer 31. Moreover, at the adhesive layer 31 side, release paper for protection is affixed.

In the manufacturing process, with regard to the separately produced element substrate 28 on which the pixel electrode 51, the above-described circuit, or the like is formed, the displaying section 30 is formed by affixing the electrophoretic sheet from which the release paper is peeled off. For this reason, in a general configuration, the adhesive layer 31 exists only at the pixel electrode 51 side.

FIG. 4 is a configuration diagram of the microcapsule 53. The microcapsule 53 has, for example, a particle diameter of about 50 μm, and is formed of an acrylic resin such as polymethylmethacrylate, polyethylmethacrylate, or the like, a urea resin, or a polymeric resin having light-transmissivity including gum arabic. The microcapsule 53 is pinched between the common electrode 52 and the above-described pixel electrode 51, and a plurality of the microcapsules 53 are arranged lengthwise and breadthwise in one pixel. In order to fill the periphery of the microcapsules 53, a binder (not illustrated) that fixes the corresponding microcapsule 53 is provided.

The microcapsule 53 is a spheroid, and at the inside thereof, dispersion medium 54 that is a solvent for dispersing the electrophoretic particle, and charged particles of a plurality of white particles (electrophoretic particle) 55 as electrophoretic particles, and a plurality of black particles (electrophoretic particle) 56 are enclosed. In this embodiment, the white particles are negatively charged, and the black particles are positively charged. In addition, the invention is not limited to this embodiment, and the white particles may be positively charged, and the black particles may be negatively charged.

The dispersion medium 54 is liquid that disperses the white particle 55 and the black particle 56 in the microcapsule 53.

As an example of the dispersion medium 54, an alcohol solvent including water, methanol, ethanol, isopropanol, butanol, octanol, or methyl cellosolve, various types of esters including ethyl acetate or butyl acetate, ketons including acetone, methyl ethyl ketone, or methyl isobutyl ketone, aliphatic hydrocarbon including pentane, hexane, or octane, alicyclic hydrocarbon including cyclohexane or methylcyclohexane, aromatic hydrocarbon such as benzenes containing a long chain alkyl group including benzene, toluene, xylene, hexyl benzene, heptyl benzene, octyl benzene, nonyl benzene, decyl benzene, undecyl benzene, dodecyl benzene, tridecyl benzene, or tetradecyl benzene, halogenated hydrocarbon including methylene chloride, chloroform, carbon tetrachloride, or 1- or 2-dichloroethane, carboxylate or other types of oil and grease, can be used independently or in a manner of a mixture thereof compounded with a surfactant or the like.

The white particle 55 is, for example, a particle formed of a white pigment (polymer or colloid) including titanium dioxide, zinc oxide, or antimony trioxide, and is, for example, positively charged.

The black particle 56 is, for example, a particle formed of a black pigment (polymer or colloid) including aniline black or carbon black, and is, for example, negatively charged.

For this reason, the white particle 55 and the black particle 56 are capable of traveling in an electric field generated by the electric potential difference between the pixel electrode 51 and the common electrode 52 in the dispersion medium 54.

It is possible to add, if necessary, a charge control agent formed of a particle including electrolyte, surfactant, metallic soap, resin, rubber, oil, varnish, or compound, a dispersing agent including titanium-based coupling agent, aluminum-based coupling agent, or silane-based coupling agent, lubricant, or a stabilizer to the pigments.

The white particle 55 and the black particle 56 are covered with an ion in the solvent, and an ion layer 57 is formed on the surface of these particles. Between the charged white particle 55 and black particle 56, and the ion layer 57, an electric double layer is formed. Generally, it is known that the charged particle of the white particle 55 or the black particle 56 hardly responds to an electric field and hardly travels even when the electric field of which the frequency is at 10 kHz or more is applied. It is known that, since the ion surrounding the charged particle is much smaller in the particle diameter than the charged particle, the ion responds to the electric field and travels when the electric field of which the frequency is at 10 kHz or more is applied.

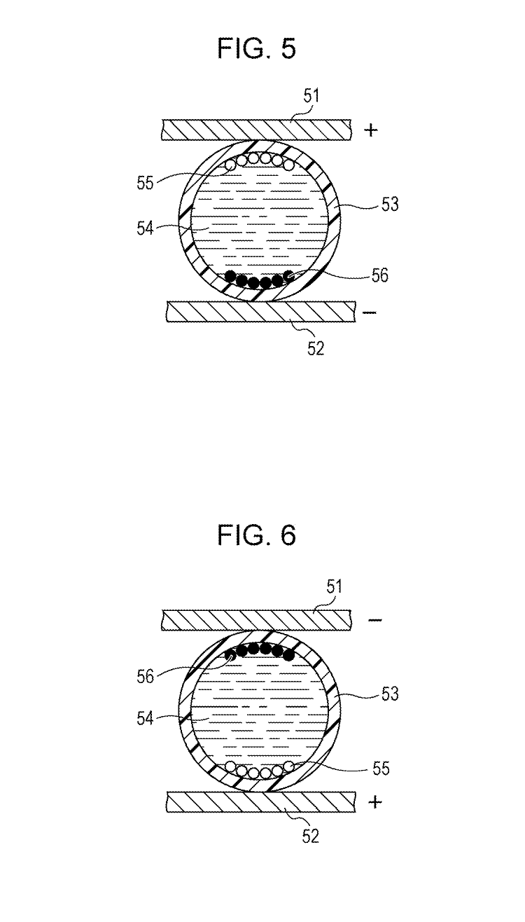

FIGS. 5 and 6 are diagrams illustrating the operation of the microcapsule 53. Here, an example of the ideal case where the ion layer 57 is not formed will be described.

In the relationship between the pixel electrode 51 and the common electrode 52, in the case where the pixel electrode 51 is at the low electric potential and the common electrode 52 is at the high electric potential, the positively charged white particle 55 gravitates toward the pixel electrode 51 inside the microcapsule 53 by Coulomb's force. Meanwhile, the negatively charged black particle 56 gravitates toward the common electrode 52 inside the microcapsule 53 by Coulomb's force. Thereby, the black particles 56 gather at a display surface side (the common electrode 52 side) inside the microcapsule 53, and when the pixel circuit P is seen from the common electrode 52 side which is the observation side, the “black” color, which is the color of the black particles 56, is recognized.

On the other hand, in the relationship between the pixel electrode 51 and the common electrode 52, in the case where the pixel electrode 51 is at the high electric potential and the common electrode 52 is at the low electric potential, the negatively charged black particle 56 gravitates toward the pixel electrode 51 inside the microcapsule 53 by Coulomb's force. Meanwhile, the positively charged white particle 55 gravitates toward the common electrode 52 inside the microcapsule 53 by Coulomb's force. Thereby, the white particles 55 gather at the display surface side (the common electrode 52 side) of the microcapsule 53, and when the pixel circuit P is seen from the common electrode 52 side which is the observation side, the “white” color, which is the color of the white particles 55, is recognized.

In this manner, by setting the voltage between the pixel electrode 51 and the common electrode 52 as a value corresponding to a tone (brightness) desired to be displayed, and making the electrophoretic particle to travel, it is possible to obtain the desired tone display.

In addition, since if the voltage application to the between of the pixel electrode 51 and the common electrode 52 is stopped, Coulomb's force is not applied, the electrophoretic particle is stopped by viscous resistance of the solvent. Since the electrophoretic particle is capable of being stopped for a long time at a predetermined position by the viscous resistance of the solvent, the electrophoretic particle has a characteristic (memory) of preserving the display state when the predetermined voltage is applied even after the application of the predetermined voltage is stopped.

The description is returned to FIG. 1. The scanning line driving circuit 42 outputs scan signals GW[1] to GW[m] to each of the scanning lines 32. Here, the scan signal output to the scanning line 32 at the ith row is marked as GW[i]. The scanning line driving circuit 42 set the scan signal GW[i] at an active level (high level) only for predetermined duration, and thereby the selecting switch Ts of n pixel circuits P subjected to the ith row is simultaneously changed to be in an on state. The progress of the scan signal GW[i] to the high level means the selection of the scanning line 32 of the ith row. In addition, the scanning line driving circuit 42 applies voltage of the high level generally by selecting the scanning line 32 one by one. However, the scanning line driving circuit has a function of applying voltage of the high level by simultaneously selecting all the scanning lines 32, if necessary. Moreover, the scanning line driving circuit 42 has a function of applying voltage of the high level by sequentially selecting only a certain scanning line 32.

The data line driving circuit 44 generates the data signals Vx[1] to Vx[n] corresponding to (n) pixel circuits P for one row selected by the scanning line driving circuit 42 and outputs the data signals to each of the data lines 34. Here, the data signal output to the data line 34 of the jth column is marked as Vx[j].

Here, a case is presumed where a data signal Vx is supplied with regard to the pixel circuits P positioned at the ith row and the jth column. In this case, the data line driving circuit 44 outputs a voltage signal of the size corresponding to a tone designated with regard to the pixel circuits P (“designated tone) as a data signal Vx[j] to the data line 34 of the jth column, synchronized to the timing when the scanning line driving circuit 42 selects the scanning line 32 at the ith row. In addition, the data line driving circuit 44 has a function of making the impedance of all the data lines 34 high, if necessary.

The data signal Vx[j] is supplied to (written in) the pixel electrode 51 of the pixel circuit P through the selecting switch Ts in the on state (refer to FIG. 2). Thereby, the voltage between the both ends of the electrophoretic element 50 of the pixel circuit P (voltage between the pixel electrode 51 and the common electrode 52) is set as a value corresponding to the designated tone of the pixel circuit P.

In this manner, the driving section 40 selects the scanning line 32 of the ith row, and also outputs the data signal Vx[j] of the size corresponding to the designated tone of the pixel circuit P positioned at the ith row and the jth column to the data line 34 of the jth column. This operation is referred to as a writing operation of the data signal Vx[j] with regard to the pixel circuit P.

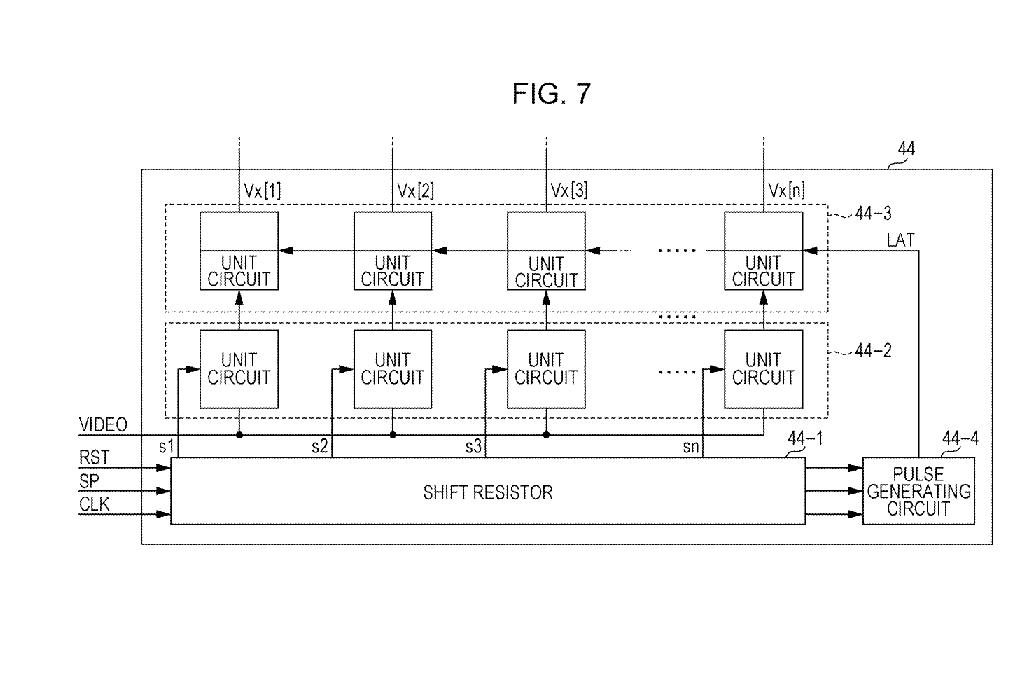

FIG. 7 is a diagram illustrating an example of one configuration of the data line driving circuit 44. As illustrated in the drawing, the data line driving circuit 44 includes a shift register 44-1, a first latching circuit 44-2, a second latching circuit 44-3, and a pulse generating circuit 44-4.

The shift register 44-1 includes n NAND gates on an output tier, and, depending on a clock signal CLK supplied from the control circuit 20, shifts a start pulse SP, and outputs sampling signals s1 to sn sequentially from a first tier corresponding to the data line 34 of the first column to an nth tier corresponding to the data line 34 of an nth column.

The first latching circuit 44-2 imports a video signal VIDEO while sequentially corresponding to the sampling signals s1 to sn from the tier where the sampling signals s1 to sn are input, and outputs the video signal VIDEO to the second latching circuit 44-3. In addition, the video signal VIDEO is supplied from the control circuit 20 to the first latching circuit 44-2.

The second latching circuit 44-3 holds the video signal VIDEO (the data signals Vx[1] to Vx[n]) supplied from each tier of the first latching circuit 44-2 at the timing when a latch pulse LAT becomes active, and supplies the data signals Vx[1] to Vx[n] for one row to the data lines 34 from the first column to the nth column.

Specifically, when, by the control of the control circuit 20, the import of the video signal VIDEO from the first tier to the nth tier (for one row) of the second latching circuit 44-3 is completed, the latch pulse LAT is input to the second latching circuit 44-3, and the data signals Vx[1] to Vx[n] are output to the data lines 34 from the first column to the nth column.

The pulse generating circuit 44-4 adds a shift register of three tiers after the nth tier, that is the last tier of the shift register 44-1, obtains the logical OR of the output and outputs the logical OR as the latch pulse LAT. Thereby, the latch pulse LAT is increased to two cycles of the clock signal CLK.

Hereinafter, the configuration and the operation of the data line driving circuit 44 will be described in detail.

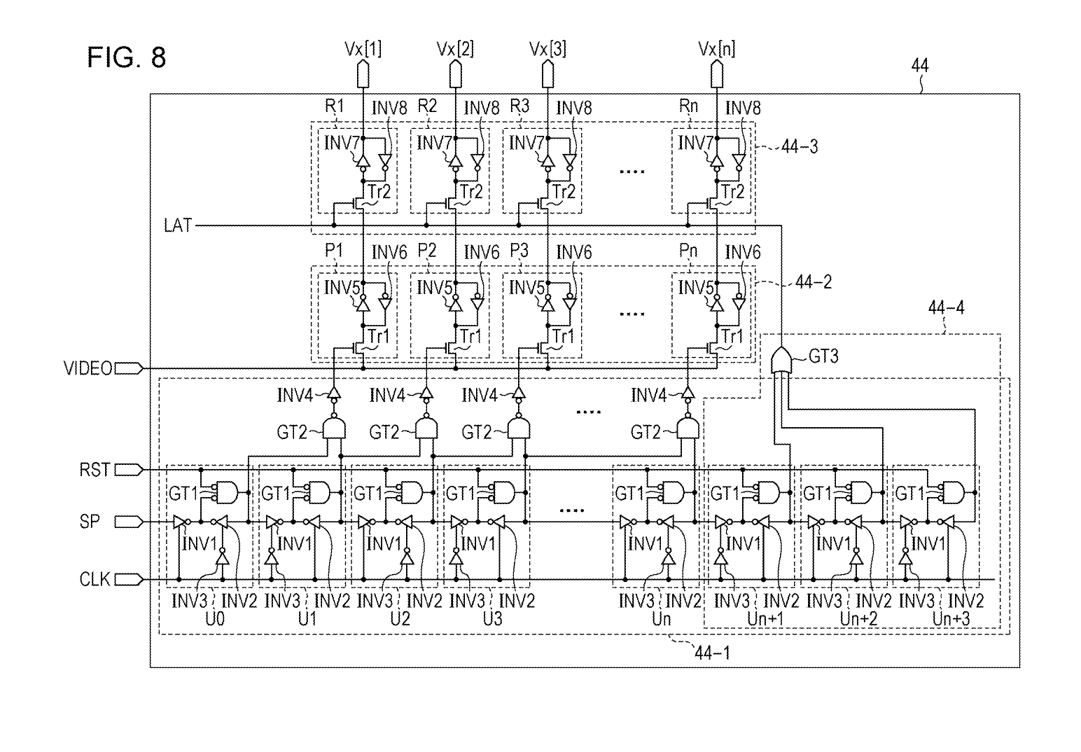

As illustrated in FIG. 8, the shift register 44-1 includes a plurality of unit circuits U0 to Un+3, a plurality of NAND gates GT2, and a plurality of inverters INV4. A unit circuit U0 on the first tier has a function of latching the start pulse SP, and a unit circuit U1 on a second tier to a unit circuit Un on an nth tier have a function of generating the sampling signals s1 to sn. In addition, the unit circuits Un+1 to Un+3 of an n+1st tier to an n+3rd tier function as a part of the pulse generating circuit 44-4 that generates the latch pulse LAT. Each of the unit circuits include clocked inverters INV1 and INV2, an inverter INV3, and a NOR gate GT1.

The clocked inverters INV1 and INV2 operate based on the clock signal CLK. In this example, the clocked inverter INV1 of the unit circuit U0 and the clocked inverter INV2 of a unit circuit U1 operate as an inverter in the case where the clock signal CLK is at the H level, and makes the impedance of the output terminal high in the case where the clock signal CLK is at L level. Meanwhile, the clocked inverter INV2 of the unit circuit U0 and the clocked inverter INV1 of the unit circuit U1 operate as an inverter in the case where the clock signal CLK is at the L level through the inverter INV3, and makes the impedance of the output terminal high in the case where the clock signal CLK is at H level.

In the NOR gate GT1, a reset signal RST is connected to an input terminal on one side, and output terminals of the clocked inverters INV1 and INV2 are connected to an input terminal on the other side. In addition, an output terminal of the NOR gate GT1 is, while being connected to an input terminal of the NAND gate GT2 of the next tier, connected to an input terminal of the clocked inverter INV2 on the same tier and to an input terminal of the clocked inverter INV1 on the next tier. Therefore, on the same tier, the NOR gate GT1, the clocked inverter INV2, and the latching circuit are formed.

In this manner, each of the unit circuits is configured of the latching circuit configured of the clocked inverter INV2 and the NOR gate GT1, and the clocked inverter INV1 that writes a logic level of the start pulse SP in the latching circuit. In addition, by exclusively controlling the clocked inverters INV1 and INV2 to be active or inactive, some of the unit circuits are operated in a state where the writing in the latching circuit is prohibited and the logic level is held, and the unit circuits adjacent thereto are operated in a state where the writing in the latching circuit is allowed, and these states are switched by ½ of the cycle of the clock signal CLK.

NAND gates GT2 and n inverters INV4 are provided respectively in response to the unit circuit U1 on the second tier to the unit circuit Un on the nth tier. An input terminal of the NAND gate GT2 is connected to an output terminal of the NOR gate GT1 in the corresponding unit circuit, and an output terminal of the NOR gate GT1 in the unit circuit on one tier before. An output terminal of each of the NAND gates GT2 is connected to an input terminal of each of the inverters INV4, and an output terminal of each of the inverters INV4 is connected to a gate terminal of each of transistors Tr1 of the first latching circuit 44-2. By such a configuration, sampling signals S1 to Sn are output from n inverters INV4.

The first latching circuit 44-2 includes n unit circuits P1 to Pn. Each of the unit circuits includes the transistor Tr1 and a latching circuit formed of inverters INV5 and INV6. A gate terminal of each of the transistors Tr1 is connected to an output terminal of each of the inverters INV4 of the shift register 44-1, and a source terminal of each of the transistors Tr1 is connected to a supply line of the video signal VIDEO. In addition, a drain terminal of each of the transistors Tr1 is connected to an input terminal of the inverter IVN5. An output terminal of the inverter INV5 is connected to an input terminal of the inverter INV6, and an output terminal of the inverter INV6 is connected to an input terminal of the inverter INV5. By such a configuration, the inverters INV5 and INV6 form a latching circuit. In the first latching circuit 44-2, the transistors Tr1 is in the on state sequentially from the tier to which the sampling signals S1 to Sn are input, and the video signal VIDEO is latched by the latching circuit during the duration corresponding to the sampling signals s1 to sn. An output terminal of each of the inverters INV5 is connected to a source terminal of each of the transistors Tr2 of the second latching circuit 44-3, and the video signal VIDEO is supplied to the second latching circuit 44-3.

The second latching circuit 44-3 includes n unit circuits R1 to Rn. Each of the unit circuits includes a transistor Tr2 and a latching circuit formed of inverters INV7 and INV8. A gate terminal of each of the transistors Tr2 is connected to a supply line of the latch pulse LAT, and a source terminal of each of the transistors Tr2 is connected to output terminals of each of the inverters INV5 of the first latching circuit 44-2. In addition, a drain terminal of each of the transistors Tr2 is connected to an input terminal of the inverter IVN7. An output terminal of the inverter INV7 is connected to an input terminal of the inverter INV8, and an output terminal of the inverter INV8 is connected to an input terminal of the inverter INV7. By such a configuration, the inverters INV7 and INV8 form a latching circuit.

If each of the transistors Tr2 is in the on state at the timing when the video signal VIDEO on the first tier to the nth tier (for one row) is output from the first latching circuit, and thereby the latch pulse LAT output from the pulse generating circuit 44-4 becomes active, by holding the video signal VIDEO supplied from each of the inverters INV5 of the first latching circuit 44-2 and outputting the video signal VIDEO from the inverter INV7 as Vx[1] to Vx[n], the data signals Vx[1] to Vx[n] are supplied to the data lines 34 at the first column to the nth column.

The pulse generating circuit 44-4 includes unit circuits Un+1 to Un+3 of n+1 to n+3 tiers of the shift register 44-1, and an OR gate GT3. The unit circuits Un+1 to Un+3 shift and outputs the output signal SRn output from the unit circuit Un at the nth tier of the shift register 44-1 for every ½ of the cycle of the clock signal CLK. In addition, the OR gate GT3 outputs the latch pulse LAT at the H level during a duration when any output signal of the unit circuits Un+1 to Un+3 is at the H level. Therefore, the latch pulse LAT of the width for two cycles of the clock signal CLK is obtained.

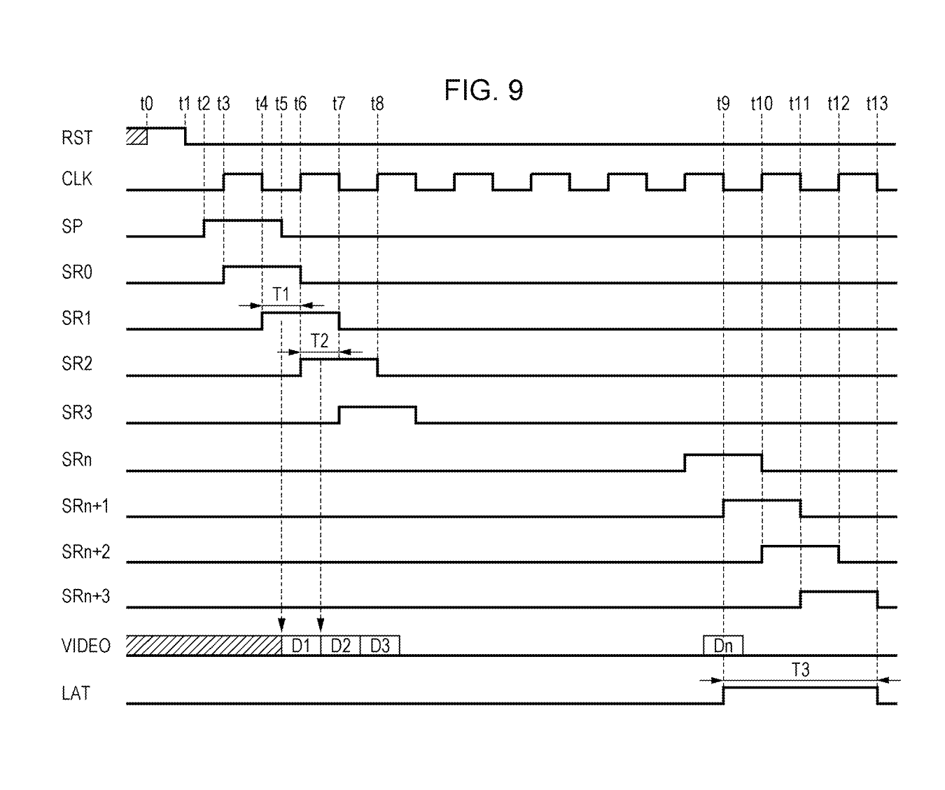

Next, with reference to the timing chart in FIG. 9, the operation of the data line driving circuit 44 will be described. As illustrated in FIG. 9, first, at time t0, the control circuit 20 raises the level of the reset signal RST from the L level to the H level, and, from the time t0 to time t1, which is after ½ of the cycle of the clock signal CLK, maintains the level of the reset signal RST at the H level. As a result, the reset signal RST at the H level is input to each of the NOR gates GT1 of each of the unit circuits of the shift register 44-1, and signals SR0 to SRn, which are output signals of each of the NOR gates GT1 of the shift register 44-1, and signals SRn+1 to SRn+3 used in the pulse generating circuit 44-4 are all reset to be at the L level.

Next, at the time t2, which is after ¼ of the cycle of the clock signal CLK from the time t1, the start pulse SP having a pulse width for one cycle of the clock signal CLK is output from the control circuit 20, and is supplied to the clocked inverter INV1 in the unit circuit U0 at the first tier of the shift register 44-1. On this tier, since the clock signal CLK is at the L level, an output terminal of the clocked inverter INV1 is in the high impedance state. Next, at time t3, which is after ¼ of the cycle of the clock signal CLK from the time t2, the clock signal CLK is supplied to the shift register 44-1 from the control circuit 20, and the level of the clock signal CLK is raised from the L level to the H level at the time t3. As a result, the clocked inverter INV1 in the unit circuit U0 on the first tier becomes active, and the clocked inverter INV1 reverts the start pulse SP at the H level supplied to the input terminal and supplies the signal at the L level to the NOR gate GT1. Therefore, at the time t3, the level of an output signal SR0 of the NOR gate GT1 on the first tier is raised from the L level to the H level. In addition, if the level of the clock signal CLK is raised from the L level to the H level at the time t3, the clocked inverter INV3 on the second and the subsequent tiers or the clocked inverter INV1 also becomes active. However, since the output of any NOR gate GT1s on the second and the subsequent tiers also remains at the L level, the level of the output signals SR1 to SRn+3 of the NOR gate GT1 on the second and the subsequent tiers is maintained as the L level.

Since the level of the clock signal CLK is maintained at the H level until time t4, and at the time t4, the level of the start pulse SP is also maintained at the H level, the level of an output signal SR0 of the NOR gate GT1 on the first tier is also maintained at the H level at the time t4.

In addition, if the level of the clock signal CLK is lowered from H level to L level at the time t4, the clocked inverter INV3 on the first tier becomes active, and the clocked inverter INV3 supplies a signal at the L level that is obtained by reversing the output signal SR0 of the NOR gate GT1 on the first tier to the input of the NOR gate GT1 on the first tier. Therefore, the level of the output signal SR0 of the NOR gate GT1 on the first tier is maintained at the H level until time t6, when the level of the clock signal CLK is changed next. In addition, if the level of the clock signal CLK is lowered from H level to H level at the time t4, the clocked inverter INV1 on the second tier becomes active, and the clocked inverter INV1 supplies a signal that is obtained by reversing the output signal SR0 of the NOR gate GT1 on the first tier to the input terminal of the NOR gate GT1 on the second tier. Therefore, at the time t4, the level of the output signal SR1 of the NOR gate GT1 on the second tier is raised from L level to H level.

As a result, the level of the output of the NAND gate GT2 in which the output signal SR0 of the NOR gate GT1 on the first tier and the output signal SR1 of the NOR gate GT1 on the second tier are supplied to the input terminal is lowered from the H level to the L level at the time t4, and, through the inverter INV4, the sampling signal s1 (not illustrated in FIG. 9) of which the level is raised from the L level to the H level at the time t4 is supplied to a gate terminal of the transistor Tr1 on the first tier of the first latching circuit 44-2.

In addition, if the level of the clock signal CLK is lowered from the H level to the L level at the time t4, the clocked inverter INV3 on the third and the subsequent tiers or the clocked inverter INV1 also becomes active. However, since the output of any NOR gate GT1s on the third and the subsequent tiers remains at the L level, the level of output signals SR2 to SRn+3 of the NOR gate GT1 on the third and the subsequent tiers is maintained as the L level.

The control circuit 20 lowers the level of the start pulse SP from the H level to the L level at time t5, which is after ¼ of the cycle of the clock signal CLK from the time t4. However, since the clocked inverter INV1 of the unit circuit U0 on the first tier remains to be inactive, the change of the level of the start pulse SP does not affect the output signal SR0 of the NOR gate GT1 on the first tier.

In addition, since the level of the clock signal CLK is maintained at the L level until time t6, and until the time t6, the level of the output signal SR0 of the NOR gate GT1 on the first tier is also maintained at the H level, the level of the output signal SR1 of the NOR gate GT1 on the second tier is also maintained at the H level at the time t6. In addition, if the level of the clock signal CLK is raised from the L level to the H level at the time t6, the clocked inverter INV3 on the second tier becomes active, and the clocked inverter INV3 supplies a signal at the L level that is obtained by reversing the output signal SR1 of the NOR gate GT1 on the second tier to the input of the NOR gate GT1 on the second tier. Therefore, the level of the output signal SR1 of the NOR gate GT1 on the second tier is maintained at the H level until time t7, when the level of the clock signal CLK is changed next.

At the time t6, which is after ½ of the cycle of the clock signal CLK from the time t4, if the level of the clock signal CLK is raised from the L level to the H level, the clocked inverter INV1 of the unit circuit U0 on the first tier becomes active, and the clocked inverter INV1 supplies the start pulse SP, of which the level is already at the L level at the time t6, to an input terminal of the NOR gate GT1 on the first tier. Therefore, at the time t6, the level of the output signal SR0 of the NOR gate GT1 on the first tier is lowered from the H level to the L level.

As a result, the level of the output of the NAND gate GT2 in which the output signal SR0 of the NOR gate GT1 on the first tier and the output signal SR1 of the NOR gate GT1 on the second tier are supplied to the input terminal is raised from the L level to the H level at the time t6, and, through the inverter INV4, the sampling signal s1 (not illustrated in FIG. 9) of which the level is lowered from the H level to the L level at the time t6 is supplied to the gate terminal of the transistor Tr1 on the first tier of the first latching circuit 44-2.

Therefore, during a duration T1 for ½ of the cycle of the clock signal CLK from the time t4 to the time t6, the transistor Tr1 on the first tier of the first latching circuit 44-2 is in the on state, and D1, which is the content of the video signal VIDEO supplied to a source terminal of the transistor Tr1 at this timing, is latched at the latching circuit on the first tier of the first latching circuit 44-2.

In addition, if the level of the clock signal CLK is raised from the L level to the H level at the time t6, the clocked inverter INV1 on the third tier becomes active, and the clocked inverter INV1 supplies a signal that is obtained by reversing the output signal SR1 of the NOR gate GT1 on the second tier to an input terminal of the NOR gate GT1 on the third tier. Therefore, at the time t6, the level of an output signal SR2 of the NOR gate GT1 on the third tier is raised from the L level to the H level.

As a result, the level of the output of the NAND gate GT2 in which the output signal SR1 of the NOR gate GT1 on the second tier and the output signal SR2 of the NOR gate GT1 on the third tier are supplied to the input terminal is lowered from the H level to the L level at the time t6, and, through the inverter INV4, a sampling signal s2 (not illustrated in FIG. 9), of which the level is raised from the L level to the H level at the time t6, is supplied to a gate terminal of the transistor Tr1 on the second tier of the first latching circuit 44-2.

In addition, if the level of the clock signal CLK is raised from L level to H level at the time t6, the clocked inverter INV3 on the fourth and the subsequent tiers or the clocked inverter INV1 also becomes active. However, since the output of any NOR gate GT1s on the fourth and the subsequent tiers remains at the L level, the level of output signals SR3 to SRn+3 of the NOR gate GT1 on the fourth and the subsequent tiers is maintained as the L level.

In addition, since the level of the clock signal CLK is maintained at the H level until time t7, and until the time t7, the level of the output signal SR1 of the NOR gate GT1 on the second tier is also maintained at the H level, the level of the output signal SR2 of the NOR gate GT1 on the third tier is also maintained at the H level at the time t7. In addition, if the level of the clock signal CLK is lowered from the H level to the L level at the time t7, the clocked inverter INV3 on the third tier becomes active, and the clocked inverter INV3 supplies a signal at the L level that is obtained by reversing the output signal SR2 of the NOR gate GT1 on the third tier to the input of the NOR gate GT1 on the third tier. Therefore, the level of the output signal SR2 of the NOR gate GT1 on the third tier is maintained at the H level until time t8, when the level of the clock signal CLK is changed next.

At the time t7, which is after ½ of the cycle of the clock signal CLK from the time t6, if the level of the clock signal CLK is changed from the H level to the L level, the clocked inverter INV1 of the unit circuit U1 on the second tier becomes active, and the clocked inverter INV1 reverses the output signal SR0 of the NAND gate on the first tier, of which the level is already at the L level at the time t7, to supply a signal on the H level to an input terminal of the NOR gate GT1 on the second tier. Therefore, at the time t7, the level of the output signal SR1 of the NOR gate GT1 on the second tier is changed from the H level to the L level.

As a result, the level of the output of the NAND gate GT2 in which the output signal SR1 of the NOR gate GT1 on the second tier and the output signal SR2 of the NOR gate GT1 on the third tier are supplied to the input terminal is raised from the L level to the H level at the time t7, and, through the inverter INV4, the level of the sampling signal s2 (not illustrated in FIG. 9) is changed from the H level to the L level at the time t7, and a signal of which the level is changed to the L level is supplied to a gate terminal of the transistor Tr1 on the second tier of the first latching circuit 44-2.

Therefore, during a duration T2 for ½ of the cycle of the clock signal CLK from the time t6 to the time t7, the transistor Tr1 on the second tier of the first latching circuit 44-2 is in the on state, and D2, which is the content of the video signal VIDEO supplied to a source terminal of the transistor Tr1 at this timing, is latched at the latching circuit on the second tier of the first latching circuit 44-2.

Hereinafter, in the same manner, from the timing when the level of an output signal of the NOR gate GT1 on the previous tier is raised from the L level to the H level, an output signal of the NOR gate GT1 on each tier is shifted for only ½ of the cycle of the clock signal CLK and the level thereof is raised from the L level to the H level, and the level is lowered from the H level to the L level after one cycle of the clock signal CLK. That is, the start pulse SP having a pulse width for one cycle of the clock signal CLK is shifted only for ½ of the cycle of the clock signal CLK and sequentially output from the NOR gate GT1 on each tier. In addition, if focused on a predetermined tier, during a duration for ½ of the cycle of the clock signal CLK when both of the level of an output signal of the NOR gate GT1 on one tier before the predetermined tier, and the level of an output signal of the NOR gate GT1 on the predetermined tier become the H level, the transistor Tr1 on the tier of the first latching circuit corresponding to the predetermined tier is in the on state, and data, which is the content of the video signal VIDEO supplied to a source terminal of the transistor Tr1 at the timing is latched at the latching circuit on the corresponding tier of the first latching circuit. In this manner, data D1 to Dn (the data signals Vx[1] to Vx[n]) of the video signals VIDEO are sequentially latched at the latch circuit in the unit circuits P1 to Pn from the first tier to the nth tier of the first latching circuit.

In addition, if the Dn of the video signal VIDEO is latched at the latching circuit in the unit circuit Pn at the nth tier, which is the last tier of the first latching circuit, and the level of the NAND gate GT1 in a unit circuit Un+1 on the n+1st tier of the shift register 44-1, that is, the unit circuit Un+1 on the n+1st tier that functions as the pulse generating circuit 44-4, is raised from the L level to the H level at time t9, the level of the latch pulse LAT, which is an output signal of the OR gate GT3 of the pulse generating circuit 44-4, is raised from the L level to the H level at the time t9.

Therefore, the transistor Tr2 on each tier of the second latching circuit 44-3 is in the on state, and the data D1 to Dn of the video signal VIDEO latched at the latching circuit on each tier of the first latching circuit 44-2 is simultaneously latched at the latching circuit on each tier of the second latching circuit 44-3.

In addition, in the pulse generating circuit 44-4, subsequent to an output signal SRn+1 of the NOR gate GT1 on the n+1st tier, an output signal SRn+2 of the NOR gate GT1 on an n+2nd tier and an output signal SRn+3 of the NOR gate GT1 on an n+3rd tier are shifted only for ½ of the cycle of the clock signal CLK, and the level thereof is sequentially raised from the L level to the H level. The level of the output signal SRn+1 of the NOR gate GT1 on the n+1st tier, the level of the output signal SRn+2 of the NOR gate GT1 on the n+2nd tier, and the level of the output signal SRn+3 of the NOR gate GT1 on the n+3rd tier are lowered from the H level to the L level respectively at time t11, at time t12, and at time t13. However, since the output signals SRn+1 to SRn+3 respectively have a duration during which the H levels are overlapped only for ½ of the cycle of the clock signal CLK, in the end, as illustrated in FIG. 9, the latch pulse LAT, which is an output signal of the OR gate GT3 maintains to be at the H level from the time t9 to the time t13, that is, during a duration T3 for two cycles of the clock signal CLK, and the level thereof is changed from H level to the L level at the time t13. In other words, the latch pulse LAT is a signal with a pulse width for two cycles of the clock signal CLK.

As a result, it is possible to make all the latching circuits from the first tier to the nth tier of the second latching circuit 44-3 corresponding to all the data lines 34 wider than the pulse width of the start pulse SP, and to drive all the latching circuits for 2 cycles of the clock signal CLK, which is sufficient time to spare. In addition, it is possible to securely latch the data signals Vx[1] to Vx[n] latched at the first latching circuit 44-2 at the second latching circuit 44-3, and moreover, it is possible to securely perform writing in all the data lines 34 by the second latching circuit 44-3, and thereby it is possible to eliminate a display defect.

### Comparative Examples

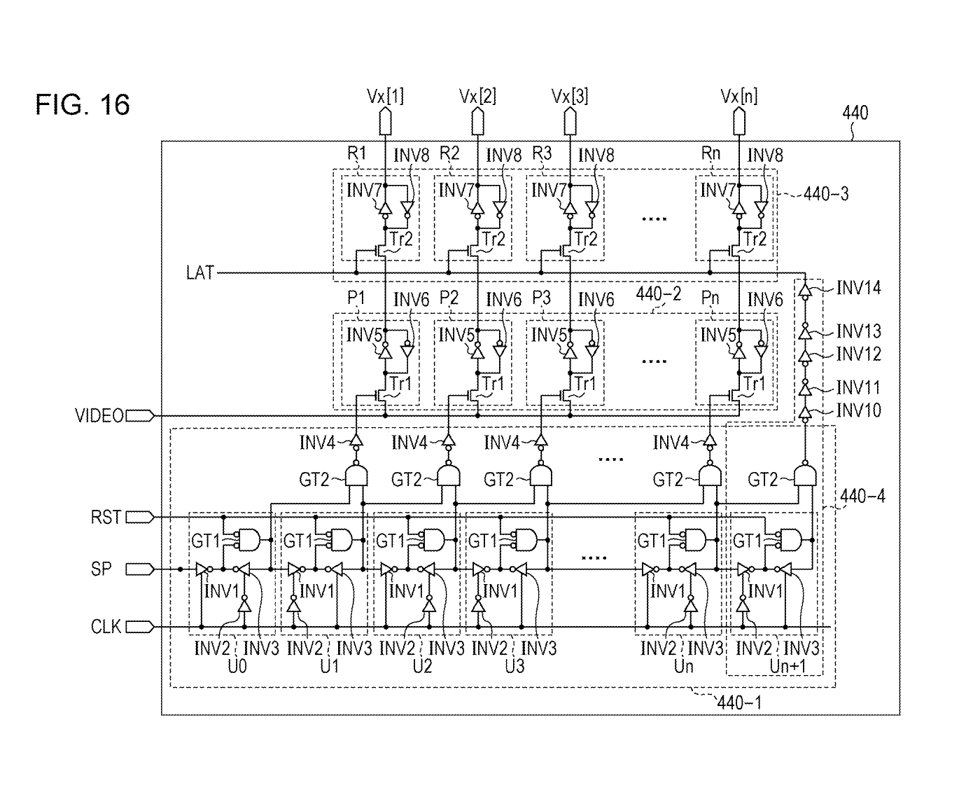

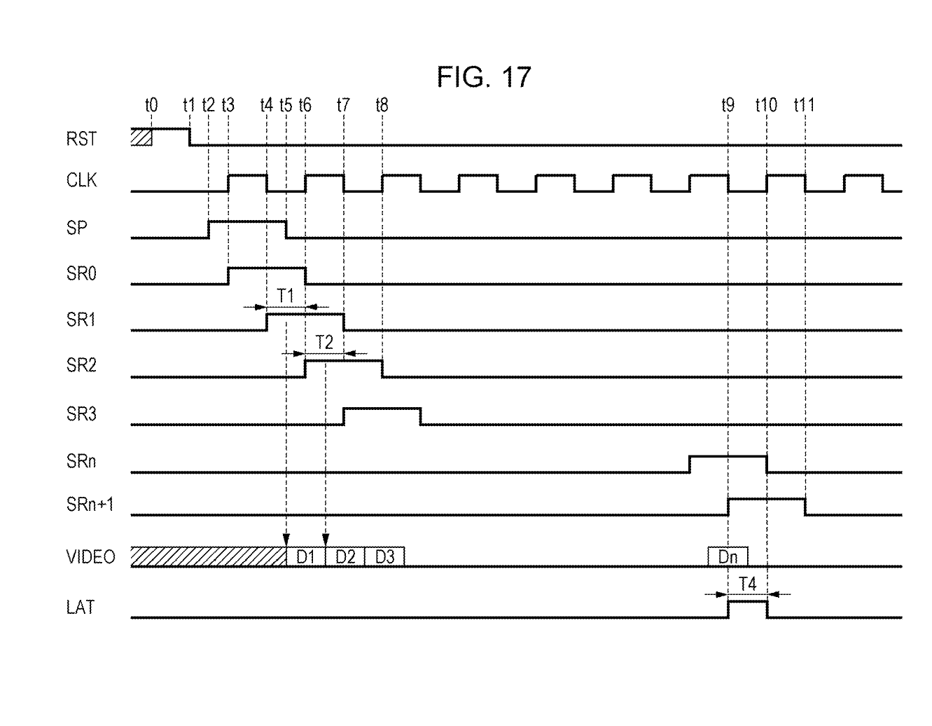

Hereinafter, a comparative example will be described with reference to FIGS. 16 and 17. A data line driving circuit 440 of the comparative example illustrated in FIG. 16 includes a shift register 440-1, a first latching circuit 440-2, a second latching circuit 440-3, and a pulse generating circuit 440-4. The first latching circuit 440-2 and the second latching circuit 440-3 respectively have the same configuration as the first latching circuit 44-2 and the second latching circuit 44-3 of the data line driving circuit 44 according to the first embodiment illustrated in FIG. 8. However, the shift register 440-1 includes, compared with the shift register 44-1 according to the first embodiment illustrated in FIG. 8, n+1 unit circuits U0 to Un+1, and the number of the unit circuits is smaller by two than in the shift register 44-1. In addition, the pulse generating circuit 440-4 is configured by a unit circuit Un+1 on the n+1st tier of the shift register 440-1, the NAND gate GT2, and five inverters INV10 to INV14.

Since the shift register 440-1 includes the unit circuits U0 to Un from the first tier to the nth tier, and the first latching circuit 440-2 and the second latching circuit 440-3 respectively have the same configuration as in the first latching circuit 44-2 and the second latching circuit 44-3 of the data line driving circuit 44 according to the first embodiment, as illustrated in FIG. 17, from the time t0 to the time t9, the operation in which the data D1 to Dn (the data signals Vx[1] to Vx[n]) of the video signal VIDEO is latched at each of the latching circuits from the first tier to the nth tier of the first latching circuit 440-2 is the same as in the first embodiment.

However, at the time t9, if the level of an output signal SRn+1 of the NOR gate GT1 of the unit circuit Un+1 on the n+1st tier is raised from the L level to the H level, the level of the output of the NAND gate GT2 of the pulse generating circuit 440-4 in which an output signal SRn of the NOR gate GT1 of the unit circuit Un on the nth tier and the output signal SRn+1 of the NOR gate GT1 of the unit circuit Un+1 on the n+1st tier are input to the input terminal is changed from the H level to the L level.

As a result, the level of the latch pulse LAT is, through the five inverters INV10 to INV14 functioning as a buffer, raised from the L level to the H level at the time t9. Therefore, the transistor Tr2 on each tier of the second latching circuit 440-3 is in the on state, and the data D1 to Dn of the video signal VIDEO latched at the latching circuit on each tier of the first latching circuit 440-2 is simultaneously latched at the latching circuit on each tier of the second latching circuit 440-3.

At the time t10, which is after ½ of the cycle of the clock signal CLK from the time t9, if the level of the output signal SRn of the NOR gate GT1 on the nth tier is changed from the H level to the L level, the level of the output of the NAND gate GT2 of the pulse generating circuit 440-4 in which the output signal SRn of the NOR gate GT1 of the unit circuit Un on the nth tier and the output signal SRn+1 of the NOR gate GT1 of the unit circuit Un+1 on the n+1st tier are input to the input terminal is raised from the L level to the H level. As a result, the level of the latch pulse LAT is, through the five inverters INV10 to INV14 functioning as a buffer, lowered from the H level to the L level at the time t10.

Therefore, the pulse LAT in the comparative example maintains, as illustrated in FIG. 17, at the H level from the time t9 to the time t10, that is, during a duration T4 for ½ of the cycle of the clock signal CLK, and the level thereof is changed from the H level to the L level at the time t10. In other words, the latch pulse LAT in the comparative example is a signal with a pulse width for ½ of the cycle of the clock signal CLK.

Therefore, there is a need to drive all the latching circuits from the first tier to the nth tier of the second latching circuit 440-3 corresponding to all the data lines 34 for exceptionally short time of ½ of the cycle of the clock signal CLK. In the comparative example, in order to prevent a display defect, the five inverters INV10 to INV14 function as a buffer to improve the driving performance of the latch pulse LAT. However, since, in such configuration, among the inverters functioning as a buffer, there is a need to handle large amount of electric current in the inverter INV14 on the last tier, there is a need to gradually increase a channel width of a transistor from the inverter INV10 on the first tier to the inverter INV14 on the last tier, and to exceptionally increase the channel width in the inverter INV14 on the last tier. As a result, there is a case where large amount of leak current is generated by the characteristic of the transistor configuring the inverters INV10 to INV14 that configure a buffer, and the electric consumption is increased.

As shown by comparing the above-described comparative example and the first embodiment, since it is possible to generate the latch pulse LAT with a pulse width with sufficient time to spare of 2 cycles for the clock signal CLK according to the aspect of the invention, without a need to provide a large buffer, it is possible to eliminate a display defect by securing writing all the data signals in all the data lines 34 while preventing the increase of the electricity consumption.

In addition, in the first embodiment, an example is described in which the unit circuits Un+1 to Un+3 of n+1 to n+3 tiers of the shift register 44-1 are used as a part of the pulse generating circuit 44-4. However, a circuit corresponding to the unit circuits Un+1 to Un+3 may be configured separately from the shift register 44-1, and used as a part of the pulse generating circuit 44-4.

### Second Embodiment

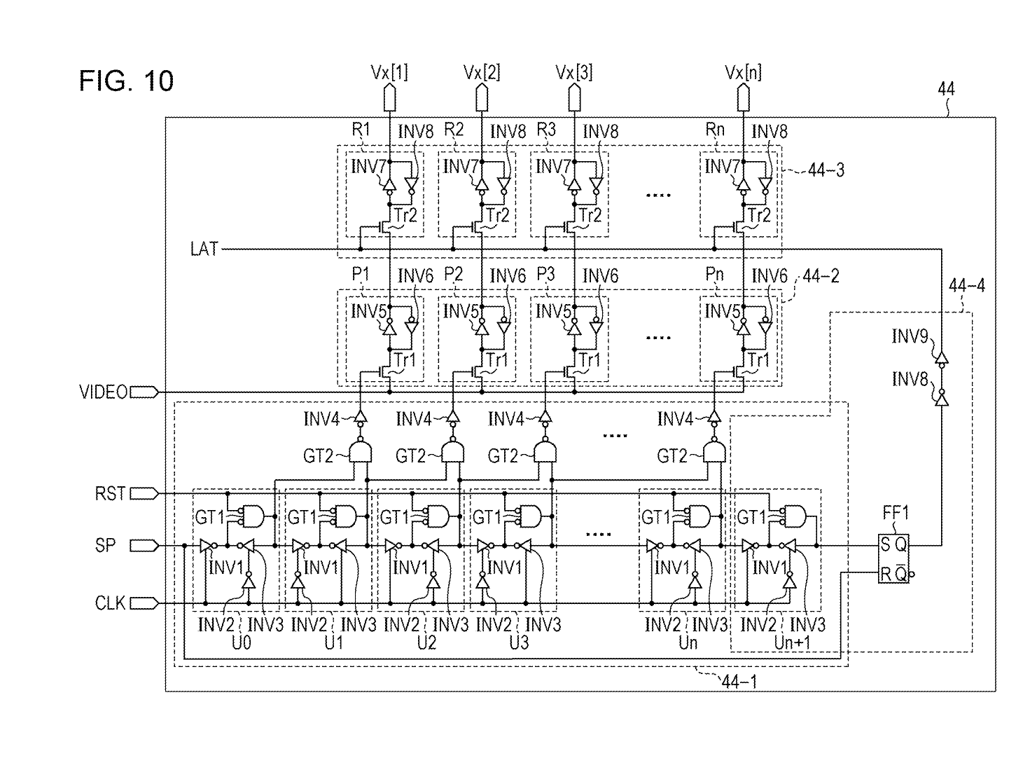

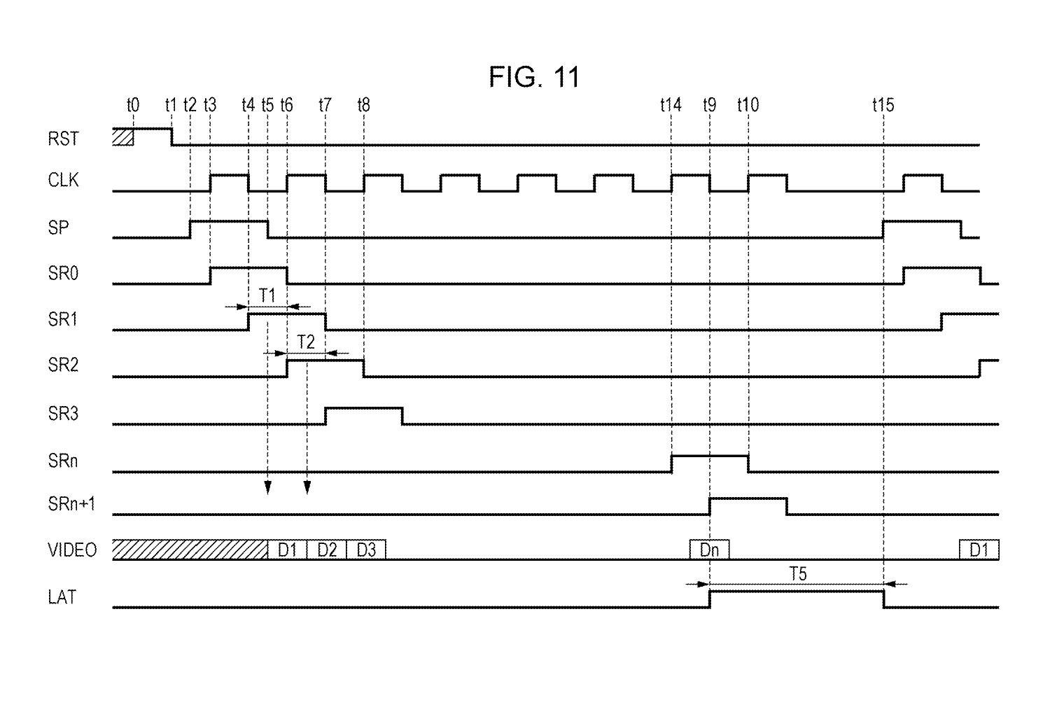

Hereinafter, the second embodiment of the invention will be described with reference to FIGS. 10 and 11. In a data line driving circuit 44 of the second embodiment, as illustrated in FIG. 10, unit circuits U0 to Un from a first tier to an nth tier are included in a shift register 44-1. In addition, a pulse generating circuit 44-4 includes a shift register of one tier, which is added after an nth tier, which is the last tier on the shift register 44-1, an SR flip-flop FF1, and inverters INV8 and INV9. Moreover, the configuration of a first latching circuit 44-2 and a second latching circuit 44-3 is the same as the configuration of the first latching circuit 44-2 and the second latching circuit 44-3 in the first embodiment.

A reset input terminal R of the SR flip-flop FF1 is connected to a supply terminal of a start pulse SP, and a set input terminal S is connected to an output terminal of a NOR gate GT1 in a unit circuit Un+1 added after the nth tier, which is the last tier of the shift register 44-1. An output terminal Q and the inverter INV8 are connected, and a latch pulse LAT is supplied.

Since the shift register 44-1 includes unit circuits U0 to Un from the first tier to the nth tier, and the first latching circuit 44-2 and the second latching circuit 44-3 respectively have the same configuration as in the first latching circuit 44-2 and the second latching circuit 44-3 according to the first embodiment, as illustrated in FIG. 11, from time t0 to time t9, the operation in which data D1 to Dn (data signals Vx[1] to Vx[n]) of a video signal VIDEO is latched at each of the latching circuits from the first tier to the nth tier of the first latching circuit 44-2 is the same as in the first embodiment.

However, at the time t9, which is after ½ of the cycle of a clock signal CLK from time t14 when the level of an output signal SRn of the NOR gate GT1 of a unit circuit Un on the nth tier is raised from an L level to an H level, if the level of an output signal SRn+1 of the NOR gate GT1 on a unit circuit Un+1 on the added one tier is raised from the L level to the H level, the output signal SRn+1 is supplied to the set input terminal S of a SR flip-flop FF1, and the level of an output signal from an output terminal Q of the SR flip-flop FF1 is raised from the L level to the H level at the time t9. As a result, the level of the latch pulse LAT is, through the inverters INV8 and INV9 functioning as a buffer, raised from the L level to the H level at time t9.

Therefore, the transistor Tr2 on each tier on the second latching circuit 440-3 is in the on state, and the data D1 to Dn of the video signal VIDEO latched at the latching circuit on each tier of the first latching circuit 440-2 is simultaneously latched at the latching circuit on each tier of the second latching circuit 440-3.

The H level of the output signal from the output terminal Q of the SR flip-flop FF1 is maintained until the level of the start pulse SP is raised from the L level to the H level at time t15 for writing in the next row. In addition, at the time t15, if the level of the start pulse SP is raised from the L level to the H level and the start pulse SP is supplied to the reset input terminal R of the SR flip-flop FF1, the level of the output signal from the output terminal Q of the SR flip-flop FF1 is lowered from the H level to the L level at the time t15.

Therefore, in the second embodiment, as illustrated in FIG. 11, the latch pulse LAT has a pulse width of the time t9 to the time t15, that is, for a duration T5, which has 2.5 times or more of the cycle of the clock signal CLK.

As a result, also in this embodiment, it is possible to make all the latching circuits from the first tier to the nth tier of the second latching circuit 44-3 corresponding to all data lines 34 wider than the pulse width of the start pulse SP, and to drive all the latching circuits for a duration which has 2.5 times or more of the cycle of the clock signal CLK, which is sufficient time to spare. In addition, it is possible to securely latch the data signals Vx[1] to Vx[n] at the second latching circuit 44-3, and moreover, it is possible to securely perform writing in all the data lines 34 by the second latching circuit 44-3, and thereby it is possible to eliminate a display defect. In addition, since there is no need for a large buffer, it is possible to suppress the increase of the electricity consumption.

### Third Embodiment

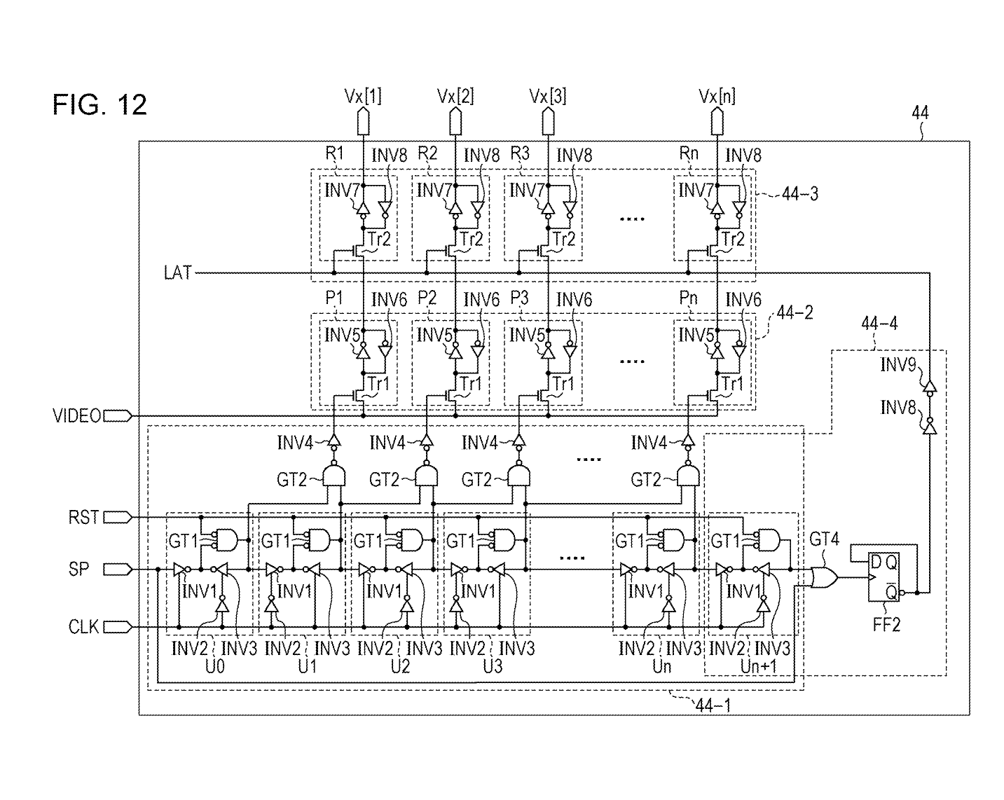

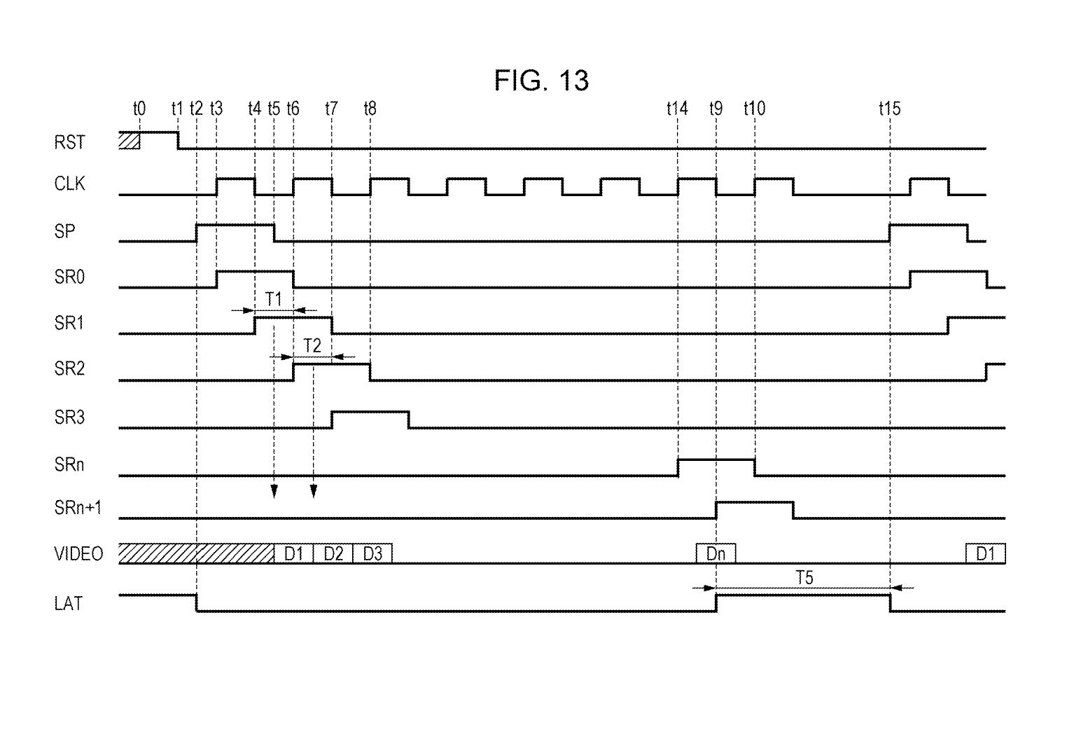

Hereinafter, the third embodiment of the invention will be described with reference to FIGS. 12 and 13. As illustrated in FIG. 12, the configuration of a shift register 44-1, a first latching circuit 44-2, and a second latching circuit 44-3 is the same as the configuration of the shift register 44-1, the first latching circuit 44-2, and the second latching circuit 44-3 in the second embodiment. However, a pulse generating circuit 44-4 in the third embodiment is different from the pulse generating circuit 44-4 in the second embodiment, and is configured of a shift register of one tier added after an nth tier, which is the last tier of the shift register 44-1, an OR gate GT4, a D flip-flop FF2, and inverters INV8 and INV9.

At an input terminal of the OR gate GT4, an output terminal of a NOR gate GT1 in a unit circuit Un+1, which is added after the nth tier, which is the last tier of the shift register 44-1, and a supply terminal of a start pulse SP are connected. The output terminal of the OR gate GT4 is connected to a clock terminal of the D flip-flop FF2. In addition, in this embodiment, a reverse output terminal of the D flip-flop FF2 is connected with an input terminal D to form a clock division circuit. In addition, the reverse output terminal of the D flip-flop FF2 is connected to the inverter INV8, and an output signal of the reverse output terminal of the D flip-flop FF2 is supplied as a latch pulse LAT through the inverters INV8 and INV9.

Since the shift register 44-1, the first latching circuit 44-2, and the second latching circuit 44-3 respectively have the same configuration as in the first latching circuit 44-2 and the second latching circuit 44-3 according to the first embodiment, as illustrated in FIG. 11, from time t0 to time t9, the operation in which data D1 to Dn (data signals Vx[1] to Vx[n]) of a video signal VIDEO is latched at each of the latching circuits from the first tier to the nth tier of the first latching circuit 44-2 is the same as in the first embodiment.

Next, the pulse generating circuit 44-4 of this embodiment will be described. In an initial state, the level of the reverse output terminal of the D flip-flop FF2 is set to an H level. In this state, as illustrated in FIG. 13, if the level of a start pulse SP is raised from an L level to the H level at time t0 for writing of the first row, the start pulse SP is supplied to a clock terminal of the D flip-flop FF2 through the OR gate GT4. The D flip-flop FF2 reverses the level of the reverse output terminal to the L level in response to a rising edge of the start pulse SP supplied to the clock terminal. As a result, at time t2, an output signal from the reverse output terminal is supplied as a latch pulse LAT, of which the level is lowered from the H level to the L level, through the inverters INV8 and INV9.

In addition, at time t9, which is after ½ of the cycle of a clock signal CLK from time t14 when the level of an output signal SRn of the NOR gate GT1 of a unit circuit Un on the nth tier is raised from an L level to an H level, if the level of an output signal SRn+1 of the NOR gate GT1 on a unit circuit Un+1 on the added one tier is raised from the L level to the H level, the output signal SRn+1 is supplied to a clock input terminal of the D flip-flop FF2. The D flip-flop FF2 reverses the level of the reverse output terminal from the L level to the H level in response to a rising edge of the output signal SRn+1 supplied to the clock terminal. As a result, at the time t9, an output signal from the reverse output terminal is supplied as a latch pulse LAT, of which the level is raised from the L level to the H level, through the inverters INV8 and INV9.

Therefore, a transistor Tr2 on each tier of the second latching circuit 44-3 is in the on state, and the data D1 to Dn of the video signal VIDEO latched at the latching circuit on each tier of the first latching circuit 44-2 is simultaneously latched at the latching circuit on each tier of the second latching circuit 44-3.

The H level of the output signal from the reverse output terminal of the D flip-flop FF2 is maintained until the level of the start pulse SP is raised from the L level to the H level at time t15 for writing in the next row. In addition, at the time t15, if the level of the start pulse SP is raised from the L level to the H level and the start pulse SP is supplied to the clock input terminal of the D flip-flop FF2, the D flip-flop FF2 reverses the level of the reverse output terminal level from the H level to the L level in response to a rising edge of the start pulse SP supplied to the clock terminal. As a result, at time t15, an output signal from the reverse output terminal is supplied as a latch pulse LAT, of which the level is lowered from the H level to the L level, through the inverters INV8 and INV9.

Therefore, in the third embodiment, as illustrated in FIG. 13, the latch pulse LAT is a signal that has a pulse width of the time t9 to the time t15, that is, for a duration T5, which is 2.5 times or more of the cycle of the clock signal CLK.

As a result, also in this embodiment, it is possible to make all the latching circuits from the first tier to the nth tier of the second latching circuit 44-3 corresponding to all data lines 34 wider than the pulse width of the start pulse SP, and to drive all the latching circuits for a duration which has 2.5 times or more of the cycle of the clock signal CLK, which is sufficient time to spare. In addition, it is possible to securely latch the data signals Vx[1] to Vx[n] at the second latching circuit 44-3, and moreover, it is possible to securely perform writing in all the data lines 34 by the second latching circuit 44-3, and thereby it is possible to eliminate a display defect. In addition, since there is no need for a large buffer, it is possible to suppress the increase of the electricity consumption.

### Modification Examples

Hereinafter, the modification examples of the above-described embodiments will be described. To avoid the repetition of description, a point different from the above-described embodiments will be described, and the description of a shared configuration or the like will be omitted.

### Modification Example 1

In the first embodiment, an example is described in which a unit circuit of three tiers of the shift register 44-1 is used as the pulse generating circuit 44-4. However, the invention is not limited to this configuration, and a unit circuit of three or more tiers may be used. In addition, a circuit corresponding to a unit circuit of three tiers or more may be configured separately from the shift register 44-1 to be used as the pulse generating circuit 44-4.

### Modification Example 2

In the above-described embodiments, an example is described where the unit circuit is configured of the NAND gate, the clocked inverter, and the inverter, and a plurality of the unit circuits configure the shift register. However, the invention is not limited to this configuration. For example, the shift register may be configured of a flip-flop or the like.

### Application Examples

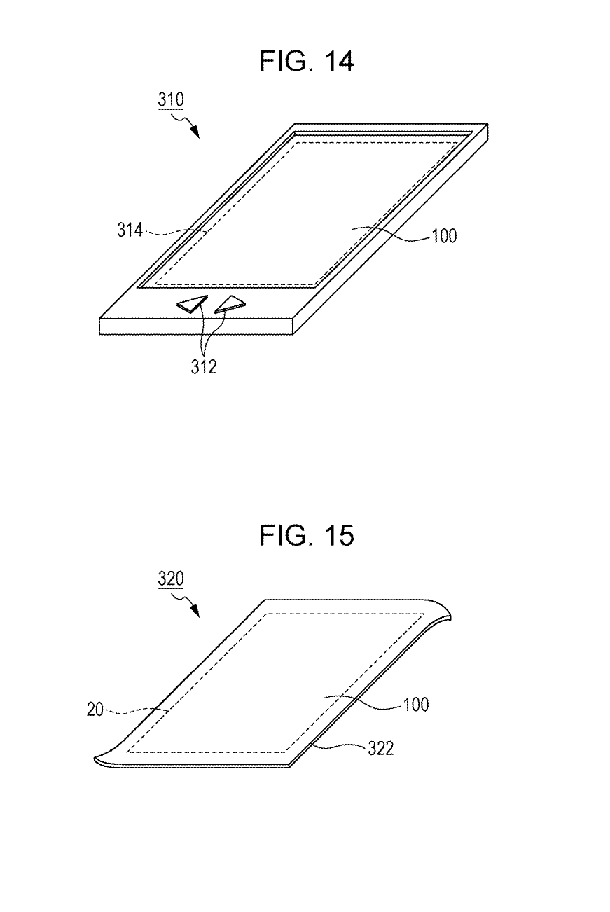

An electronic apparatus to which the invention is applied will be illustrated hereinafter. In FIGS. 14 and 15, the exterior of the electronic apparatus in which the above-illustrated electrophoretic display device 100 is adopted is illustrated.

FIG. 14 is a perspective view of an information terminal (electronic book) 310 in a portable form in which the electrophoretic display device 100 is adopted. As illustrated in FIG. 14, the information terminal 310 is configured of an operator 312 operated by a user, and the electrophoretic display device 100 that displays an image on the displaying section 314. If the operator 312 is operated, an image displayed on the displaying section 314 is changed.

FIG. 15 is a perspective view of an electronic paper 320 in which the electrophoretic display device 100 is adopted. As illustrated in FIG. 15, the electronic paper 320 is configured of the electrophoretic display device 100 formed on the surface of a flexible substrate (sheet) 322 or the like.

The electronic apparatuses to which the invention is applied are not limited to the above examples. For example, it is possible to adopt the electrooptical device of the invention in various electronic apparatuses including a mobile phone, a watch (a wristwatch), a portable sound-reproducing system, an electronic organizer, or a display device equipped with a touch panel.

In addition, the display element of the invention is not limited to the electrophoretic element, and may be applied to an organic EL element, a liquid crystal element, or the like. Therefore, the electrooptical device of the invention is not limited to the electrophoretic display device, and may be applied to an organic EL display device, an inorganic EL display device, a liquid crystal display device, an electrochromic display device, or the like. In addition, also as an example of the electronic apparatus, it is possible to adopt the electrooptical device of the invention in various electronic apparatuses including an information terminal in which an organic EL display device or a liquid crystal display device is used, a mobile phone, a watch (a wristwatch), a portable sound-reproducing system, an electronic organizer, a display device equipped with a touch panel, a tablet, an electronic book, or a smartphone.

The entire disclosure of Japanese Patent Application No. 2015-010207, filed Jan. 22, 2015 is expressly incorporated by reference herein.

What is claimed is:

1. A data line driving circuit of an electrooptical device which includes a displaying section that includes a plurality of pixels arranged in a matrix form, a scanning line driving circuit, a data line driving circuit, in which writing of a data signal is performed through a data line for each of the plurality of pixels corresponding to one scanning line, the circuit comprising:
a first latching circuit that latches the data signal to be written in the pixel of each column corresponding to the one scanning line by a sampling signal corresponding to each column;
a shift register that transmits a predetermined pulse signal and outputs the sampling signal corresponding to each column;
a second latching circuit that simultaneously latches the data signal to be written in the pixel of each column latched in the first latching circuit by a latch pulse signal and supplies the data signal to the data line of each column; and
a pulse generating circuit that generates a latch pulse signal of a pulse width wider than the pulse width of the predetermined pulse signal based on the predetermined pulse signal transmitted to a tier corresponding to the last column in order to generate the sampling signal corresponding to the last column output from the shift register.

2. The data line driving circuit of an electrooptical device according to claim 1,
wherein the pulse generating circuit includes a circuit transmitting the predetermined pulse signal, further transmits the predetermined pulse signal transmitted to the tier corresponding to the last column at the interval shorter than the pulse width of the corresponding pulse signal for a plurality of tiers, and generates the latch pulse signal of the pulse width wider than the pulse width of the predetermined pulse signal by performing a logical OR of the transmitted plurality of pulse signals.

3. The data line driving circuit of an electrooptical device according to claim 1,
wherein the pulse generating circuit includes an SR flip-flop circuit, and, while inputting the predetermined pulse signal transmitted to the tier corresponding to the last column into a set input terminal of the SR flip-flop circuit, inputs the predetermined pulse signal before the transmission is performed by the shift register into a reset input element of the SR flip-flop circuit to generate the latch pulse signal of the pulse width wider than the pulse width of the predetermined pulse signal.

4. The data line driving circuit of an electrooptical device according to claim 1,
wherein the pulse generating circuit includes an D flip-flop circuit in which a reverse output terminal and a data input terminal are connected, and inputs the predetermined pulse signal transmitted to the tier corresponding to the last column, or the predetermined pulse signal before the transmission is performed by the shift register into a clock terminal of the D flip-flop circuit to generate the latch pulse signal of the pulse width wider than the pulse width of the predetermined pulse signal.

5. An electrooptical device, comprising:
line driving circuit according to claim 1.

6. An electrooptical device, comprising:
line driving circuit according to claim 2.

7. An electrooptical device, comprising:
line driving circuit according to claim 3.

8. An electrooptical device, comprising:
line driving circuit according to claim 4.

9. An electronic apparatus, comprising:
the electrooptical device according to claim 5.

10. An electronic apparatus, comprising:
the electrooptical device according to claim 6.

11. An electronic apparatus, comprising:
the electrooptical device according to claim 7.

12. An electronic apparatus, comprising:
the electrooptical device according to claim 8.
